(19) United States
(12) Patent Application Publication
(10) Pub. No.: US 2014/0084645 A1
(43) Pub. Date: Mar. 27, 2014

(54) CHILD SEAT FOR A MOTOR VEHICLE

(71) Applicant: TAKATA AG, Aschaffenburg (DE)

(72) Inventors: Benedikt HEUDORFER, Nersingen (DE); Reiner Nett, Aschaffenburg (DE); Uwe Dierks, Blaubeuren (DE)

(73) Assignee: TAKATA AG, Aschaffenburg (DE)

(21) Appl. No.: 14/091,853

(22) Filed: Nov. 27, 2013

Related U.S. Application Data
(63) Continuation of application No. PCT/EP2012/059984, filed on May 29, 2012.

(30) Foreign Application Priority Data
May 30, 2011 (DE) DE 102011076702.9

(51) Int. Cl. B60N 2/28

(52) U.S. Cl. CPC B60N 2/2884
USPC 297/216.11

(57) ABSTRACT

A child seat for a motor vehicle is provided. The child seat comprises an inside for accommodating a child, an outside, at least one inflatable structure which is arranged on the outside of the child seat, and at least one gas source, wherein in the case of a collision of a motor vehicle in which the child seat is arranged the gas source provides gas for the at least one inflatable structure. It is provided that on its outside the child seat comprises at least one first inflatable structure, which during filling with gas is inflated substantially in lateral direction, and on its outside comprises at least one second inflatable structure, which during filling with gas is inflated substantially in a direction towards the front.

### CROSS-REFERENCE TO A RELATED APPLICATION

This application is a continuation of International Patent Application Number PCT/EP2012/059984, filed on May 29, 2012, which was published in German as WO 2012/163889. The foregoing international application is incorporated by reference herein.

### BACKGROUND

This invention relates to a child seat for a motor vehicle.

It is known to provide child seats with energy-absorbing deformation pads. The same can be made of rigid foams or, as described in EP 1 948 474 B1, of air cushions.

From U.S. Pat. No. 7,717,506 B2 it is known to mount an energy-absorbing pad on the outside of a child seat. In the case of the impact of a child's body, the energy-absorbing pad is compressed, wherein air escapes through an opening.

From EP 1 486 384 A2 it is known to mount both a pad and an inflatable gas bag on the inside of a child seat. In one configuration, a gas generator is associated to the gas bag for filling the gas bag with gas, when there is a corresponding trigger signal.

DE 44 18 028 A1 describes a child restraint system, in which a seat shell serves as carrier body for an inflatable gas cushion. It can be provided to support the seat shell itself with respect to the vehicle via gas cushions.

For reasons of comfort, energy-absorbing deformation pads must be positioned at a distance to the child's body, so that their extension towards to the child's body is limited. The size of the pads towards the front likewise is limited, in order to provide for an acceptable visual comfort of the child. The size of pads arranged on the outside of the child seat also is limited, in order to provide for a compatibility with different vehicle interiors.

This leads to the fact that in the case of a crash the child's body experiences a certain relative movement with respect to the child seat and the child seat experiences a movement relative to the motor vehicle, without crash energy being absorbed thereby. Furthermore, this leads to a reduced energy absorption of the energy-absorbing paddings, since the same only have a small deformation path with a prescribed outside width of the child seat. This prevents an optimum restraining effect with minimized loads on the child's body.

### SUMMARY

It is an object underlying the present invention to provide a child seat for a motor vehicle which improves the restraining effect of the child seat to the effect that the loads on the child's body are reduced in the case of a crash.

According to an exemplary embodiment of the invention, it is provided that at least one inflatable structure is arranged on the outside of the child seat, namely such that on its outside the child seat includes at least one first inflatable structure, which during filling with gas is inflated substantially in lateral direction, and on its outside includes at least one second inflatable structure, which during filling with gas is inflated substantially in a direction towards the front. In the case of a collision, the at least one inflatable structure mounted on the outside of the child seat can support on the vehicle structure after inflation and thereby lead to an early coupling of the child seat including its occupant to the vehicle deceleration. A relative movement between the child seat and the vehicle structure is avoided or at least reduced.

The first inflatable structure, which is inflated substantially in lateral direction, and the second inflatable structure, which is inflated substantially in a direction towards the front, thus in combination are formed in a lateral boundary structure or at another point of the child seat. The first and the second inflatable structure can be provided by separately inflatable structures or form parts of a common inflatable structure, for example of an inflatable gas bag which includes two gas bag chambers or gas bag portions connected with each other.

According to the invention, the inflatable structure correspondingly is arranged on the outside of the child seat body, i.e. during filling with gas the inflatable structure is inflated not in direction of a child's body, which is sitting in the child seat, but away from the child seat.

Due to one or more inflated structures, the solution according to the invention provides for utilizing free spaces in the region around the child seat, in particular free spaces between the child seat and a lateral vehicle structure, for energy absorption in the case of a crash. Due to one or more structures which are inflated in the case of a crash, an additional energy absorption path is provided and hence an immediate and maximum energy absorption becomes possible in the case of a crash (so-called “ride-down effect”). The loads on the child's body are reduced in this way.

In exemplary embodiments of the invention it can be provided to increase the distance of deformation pads arranged on the inside to the child and to guide such pads towards the front to a reduced extent, so that seating comfort and vision of the child are improved, since other energy absorption paths for the absorption of crash forces are provided by the solution according to the invention.

Due to the arrangement of at least one inflatable structure on the outside of the child seat according to the invention it furthermore is ensured that a shooting risk, in particular in an OoP situation (OoP=“Out of Position”), is excluded for the infantile seat occupant.

In one exemplary aspect of the invention it is provided that the child seat includes at least one lateral boundary structure and at least one inflatable structure is arranged on the outside of the lateral boundary structure such that it is inflated substantially in lateral direction away from the lateral boundary structure. This provides for a fast support on a laterally arranged vehicle structure.

The lateral boundary structure, on the outside of which at least one inflatable structure is arranged, is formed for example by a side bolster of the child seat, which proceeding from a backrest and/or a head region of the child seat extends towards the front and laterally shields the child's body and supports the same laterally in the case of a crash. An inflatable structure can, however, also be formed in another region of a lateral boundary structure of the child seat, for example in the side region of the seating region of the child seat.

The indication that the inflatable structure is inflated substantially “in lateral direction” away from the lateral boundary structure, relates to the condition of the child seat as mounted in a motor vehicle. The term “in lateral direction” thus relates to a direction which extends transversely to the longitudinal vehicle direction. Correspondingly, the indication of an inflation of the inflatable structure “in a direction towards the front” means that in the condition as mounted in the motor vehicle the inflatable structure is inflated and extends substantially in longitudinal vehicle direction.

In a further exemplary aspect of the invention it is provided that the child seat includes at least one lateral boundary structure and at least one inflatable structure is arranged on the outside of the lateral boundary structure such that it is inflated substantially in a direction towards the front away from the lateral boundary structure. In this case, the inflatable structure primarily serves an improved head protection of the child's body in the case of a side crash. The inflatable structure for example is arranged on the or adjacent to the end face of the lateral boundary structure.

One design variant of the present invention provides that in the inflated condition the first inflatable structure, which is inflated in lateral direction, is pressurized with a higher pressure than the second inflatable structure, which extends substantially in a direction towards the front. This provides for a fast support of the child seat on a lateral vehicle structure by ensuring a high input of energy. For the inflatable structure substantially extending towards the front, however, the pressurization with a lower pressure is sufficient, in order to ensure an adjusted head protection function for the infantile occupant.

In a further exemplary aspect of the invention it is provided that to the at least one gas source a valve unit with openable valves is associated, which via at least one gas line is connected with the at least one inflatable structure. The gas source for example is formed as cold gas generator. By opening the valves in the case of a collision, an inflation of the inflatable structures is provided.

Furthermore, a control means integrated into the child seat can be provided, which is formed and provided to control the gas source or a unit connected therewith in the case of a collision of a motor vehicle in which the child seat is arranged in such a way that gas is provided for inflating the at least one inflatable structure. The control means can comprise a detection unit which is formed and provided to detect whether the child seat is coupled to an ISOfix latching of a vehicle, wherein the control means triggers a provision of gas only for this case. An undesired activation, for example when dropping the child seat, thereby is avoided.

In one exemplary aspect, the control means can be formed and provided to open the valves of the above-mentioned valve unit in the case of a collision, so that the at least one inflatable structure is filled with gas of the gas source.

In exemplary embodiments, the at least one inflatable structure is arranged on the outside of a side bolster, a head region, a backrest or a seating region of the child seat.

The inflatable structure in principle can be any structure which can be arranged or formed on the outside of a child seat and which experiences an increase in volume during filling with gas. For example, this can be an inflatable structure of an elastic material. In one aspect of the invention it is provided that the inflatable structure is formed by a gas bag which is deployed during filling with gas. The gas bag for example is made of a fabric, but can also be made of other materials, such as e.g. an elastic film.

In one exemplary aspect, the child seat includes a plurality of folded gas bags on the outside of at least one lateral boundary structure. Alternatively, it can be provided that the child seat includes at least one folded gas bag on the outside of at least one lateral boundary structure, which includes several chambers or several regions which are deployed in different directions.

### BRIEF DESCRIPTION OF THE DRAWINGS

The invention will be explained in detail below by means of several exemplary embodiments with reference to the Figures of the drawing.

FIG. 1 shows a side view of a first exemplary embodiment of a child seat, wherein the child seat includes a first gas bag extending substantially in lateral direction and a second gas bag extending substantially in a direction towards the front.

FIG. 2 shows a section through the child seat of FIG. 1 along line A-A.

FIG. 3 shows a section through the gas bag of FIG. 1 along line B-B.

FIG. 4 shows a second exemplary embodiment of a child seat which exclusively includes a gas bag extending substantially in a lateral direction.

FIG. 5 shows a third exemplary embodiment of a child seat which exclusively includes a gas bag extending substantially in a direction towards the front.

FIG. 6A schematically shows first design variants for the arrangement of a gas bag in the side bolster region of a child seat.

FIG. 6B schematically shows second design variants for the arrangement of a gas bag in the side bolster region of a child seat.

FIG. 7 shows a first exemplary embodiment of the arrangement of a gas source in a child seat.

FIG. 8 shows a second exemplary embodiment of the arrangement of a gas source in a child seat.

### DETAILED DESCRIPTION

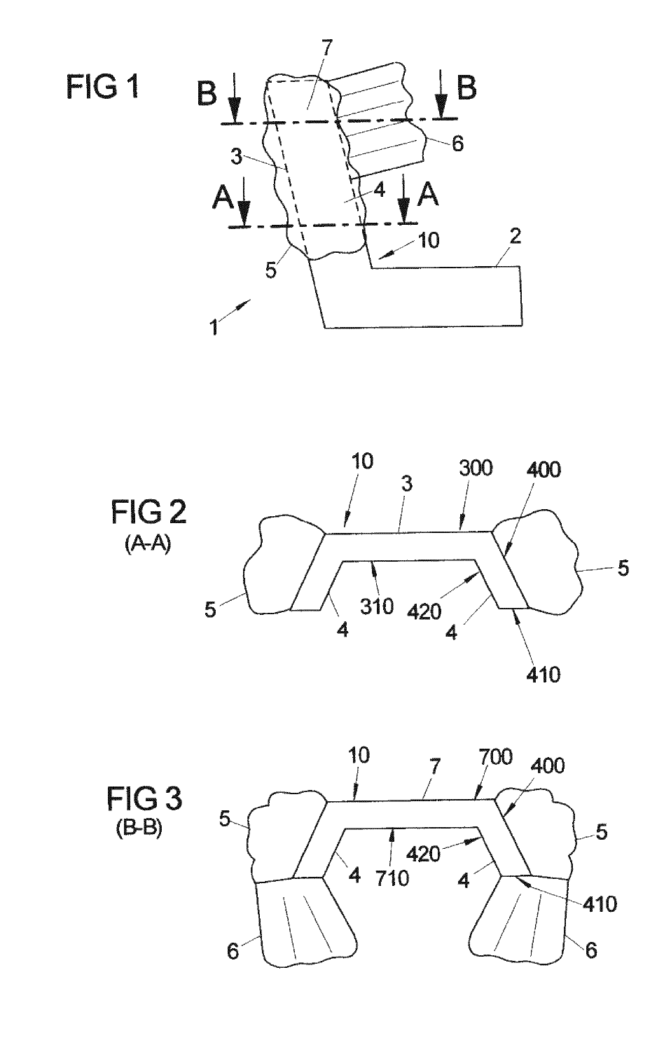

Schematically and in a side view. FIG. 1 shows a child seat 1 which includes a seating region 2, a backrest 3, a head region 7 and two side bolsters 4.

Based on the condition of the child seat 1 as mounted in a motor vehicle—the side bolsters 4 extend from the right and left side of the backrest 3 and the head region 7 towards the front and can include a wall-like structure. They can each be formed as continuous structure or adjacent to the head region 7 and the backrest 3 by separate side bolster structures. It can furthermore be provided that the side bolsters 4 extend into the seating region 2 and provide a lateral support of a child's body also in the seating region

In the schematic representation of FIG. 1 further components of a child seat, such as a belt system, seat and side cushions made of foam and optionally a pivotable bracket are not shown.

As can be taken in particular from the sectional representations of FIGS. 2 and 3, the child seat 1 forms an inside which is formed by inner surfaces 310, 710 of the backrest 3 and of the head region 7 as well as inner surfaces 420 of the side bolsters 4 (and by non-illustrated inner surfaces of the seating region 2). The inside 310, 710, 420 serves the accommodation of a child and surrounds the child sitting in the child seat 1. The inside 310, 710, 420 of the child seat 1 is exposed to the actual or potential contact with the child's body.

The child seat 1 furthermore has an outside. The outside is formed by the rear side 300, 700 of the backrest 3 and the head region 7 as well as the outside 400 and the end face 410 of the side bolsters 4. In addition, the seating region 2 also forms an outside. It should be noted that in the context of the present invention also the end face 410 of the side bolster 4 is referred to as outside of the child seat.

The seating region 2, the backrest 3, the head region 7 and the side bolsters 4 form a child seat body 10 which provides the supporting structure of the child seat 1. The child seat body 10 can have a one-part or multipart design. It can comprise one or more seat shells, which also can have a multi-walled design, and for example is made of a plastic material. It can also be provided that various regions, for example the seating region 2 and the backrest 3 of the child seat body 10 are pivotally connected with each other. The child seat body 10 thus is formed by those components of the child seat which provide the child seat with shape and stability. The term is to be understood broadly and for example also comprises a possibly existing base (not shown), with respect to which other parts of the child seat body are shiftable by changing the inclination of the backrest.

In the exemplary embodiment of FIGS. 1 to 3 the child seat 1 includes a first gas bag 5 and a second gas bag 6 as inflatable structures on the outside of each of the two side bolsters 4. The first gas bag 5 is arranged and formed on the outside of the side bolster 4 such that it is deployed substantially in lateral direction away from the side bolster 4. The second gas bag 6 is arranged and formed on the outside of the side bolster 4 such that it is deployed substantially in a direction towards the front away from the side bolster 4.

The first gas bag 5 is pressurized with a high pressure, in order to ensure a fast support of the child seat 1 on a lateral vehicle structure with a high input of energy. The gas bag 6 extending towards the front, on the other hand, is pressurized with a lower pressure, as it, adapted to the child, primarily fulfills a head protection function. The gas bag 6 can be formed such that it additionally provides a thorax protection.

The sectional representation of FIG. 2 only shows the first gas bag 5, since the second gas bag 6 has a smaller extension in vertical direction and extends in vertical direction in particular only in the head region 7, which provides a head protection. The first gas bag 5 on the other hand extends in vertical direction both in the region of the backrest 3 and in the head region 7, wherein it can however also be provided alternatively that the first gas bag 5 only extends in one of these regions 3, 7.

The sectional representation of FIG. 3 shows both gas bags 5, 6 in the inflated condition.

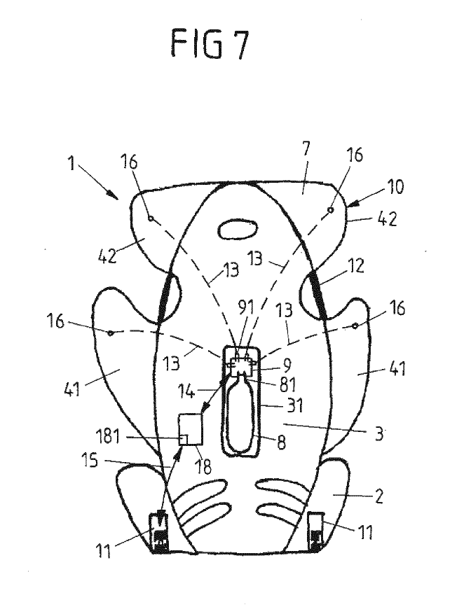

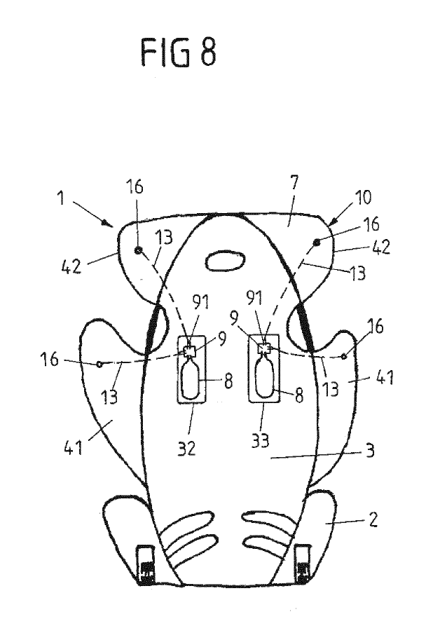

For filling the two gas bags 5, 6 with different pressure it can be provided that the gas bags 5, 6 are filled with gas of a gas source to a defined extent by means of special switches and/or valves, as will yet be explained by way of example with reference to FIGS. 7 and 8. Alternatively, it can be provided that to each gas bag 5, 6 a separate gas generator is associated.

It should be noted that the two gas bags 5, 6 need not necessarily be formed by two separate gas bags. It is likewise possible that the gas bags 5, 6 are formed by different chambers of a single gas bag. For realizing a different pressure in such gas bag chambers it can be provided, for example, that the one chamber first is filled with gas and only upon reaching a specified internal pressure a valve for filling also the second chamber is opened in a wall which separates the two chambers. The two gas bags 5, 6 also can be formed by merely different regions of a single gas bag.

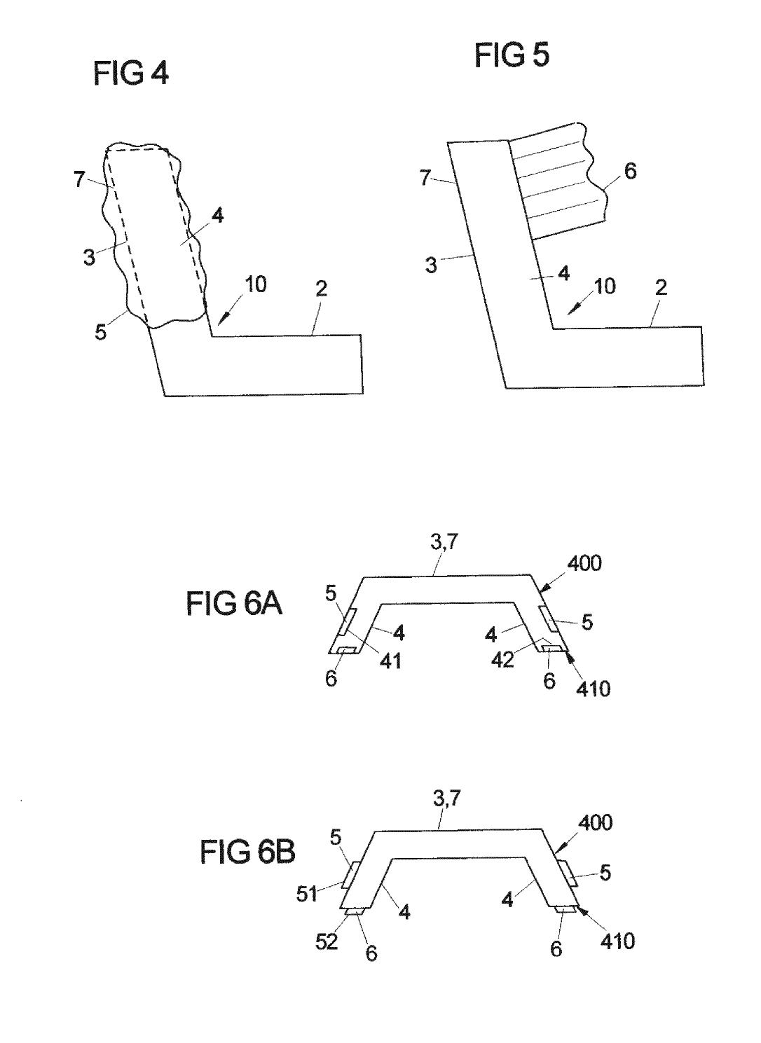

FIG. 4 shows an alternative exemplary embodiment in which merely one gas bag 5 is provided in the region of each side bolster 4, which in the folded condition is located on the outside of the side bolster 4 and in the case of a collision is deployed substantially in lateral direction away from the side bolster 4. In one exemplary embodiment it is pressurized with high pressure, in order to ensure a fast support of the child seat with respect to a lateral vehicle structure.

In the exemplary embodiment of FIG. 5 a gas bag 6 merely is provided in the region of each side bolster 4, which adjacent to the head region 7 is deployed substantially in a direction towards the front away from the side bolster 4. Such gas bag 6 primarily serves the realization of an adjusted head protection function for an infantile occupant.

FIGS. 6A and 6B schematically show exemplary embodiments for the arrangement of a folded gas bag package at the child seat. According to FIG. 6A, the child seat includes cutouts 41, 42 in the region of the side bolsters 4, which each serve for accommodating a folded gas bag package 5, 6. The cutouts 41, 42 are formed on the lateral outside 400 and the end-face outside 410 of the side bolsters 4.

According to the exemplary embodiments of FIG. 6B, the folded gas bag packages 5, 6 are arranged in gas bag housings 51, 52, which are attached to the lateral outside 400 and the end-face outside 410 of the side bolsters 4, for example by means of non-illustrated screw or rivet connections.

It should be noted that the stowing variants shown in FIGS. 6A and 6B for the respective gas bags 5, 6 are to be understood by way of example only. Gas bags also can be arranged on the outside of the child seat in another way and at another point. For example, it can also be provided that a laterally deploying gas bag is formed on the outside of the lateral boundary of the seating region 2 of the child seat, wherein such gas bag also provides a fast support on the vehicle structure in the case of a collision and thereby prevents a relative movement of the seat relative to the motor vehicle.

FIG. 7 shows a first exemplary embodiment for providing a gas source for inflating the inflatable structures arranged or formed on the outside of the child seat. According to FIG. 7, a child seat 1 (which in FIG. 7 is shown from the rear) in turn includes a seating region 2, a backrest 3 and a head region 7. Two lateral side bolsters 41 adjoin the backrest 3 and two lateral side bolsters 42 adjoin the head region 7. The head region 7 extends above the back region 3. Both in the two side bolsters 41 of the backrest 3 and at the lateral ends or side bolsters 42 of the head region 7 a gas bag or another inflatable structure (not shown separately in FIG. 7) each is arranged on the outside of the child seat body 10.

For filling these inflatable structures a central gas source is provided in the form of a cold gas generator 8, which includes compressed gas stored in a pressure chamber. The cold gas generator 8 comprises a mouthpiece 81 which can be opened by an ignition mechanism, for which case the compressed gas escapes from the pressure vessel.

The cold gas generator 8 is arranged in a cutout 31 which is centrally and symmetrically formed in the back of the backrest 3. The mouthpiece 81 is coupled with a valve unit 9 which includes a plurality of valves 91, which for example are formed as check valves. Via the valves 91 the valve unit 9 is connected with a plurality of gas lines 13, wherein each gas line 13 ends at an opening 16 via which an inflatable structure arranged there can be filled with the compressed gas of the gas generator 8.

For opening the valves 91 and for thereby charging the individual gas bags with gas a control means 18 is provided, which can comprise a crash sensor. It should be noted that the control means 18 is merely schematically shown in FIG. 7. Its actual location can be at another point. For example, the control means 18 can be integrated into the valve unit 9. In each case it is connected with the valve unit 9 via a connection 14.

The control means 18 is formed and provided to detect a collision of a motor vehicle in which the child seat 1 is arranged and for this case open the valves 91 of the valve unit 9 such that each of the inflatable structures is filled with gas with the desired pressure. For this purpose, further switches and valves can be provided.

In the illustrated exemplary embodiment the child seat comprises two ISOfix latching devices 11 which provide for rigidly connecting the child seat 1 with the car body in a safe and simple way (corresponding to the standard ISO 13216). In one design variant it is provided that the control means 18 comprises a detection unit 181, which detects whether the child seat 1 currently is mounted in a motor vehicle, For this purpose, the detection unit 181 for example detects a stress condition or the like of the ISOfix latching devices 11 via a schematically illustrated electrical connection 14. If the detection unit 181 detects no attachment of the child seat 1 in a vehicle, it is provided that in this case the control means 18 cannot activate the protection system, i.e. the inflatable structures cannot be filled with gas. Thus, an activation lock is coupled with the ISOfix latching. It can thereby be prevented that the protection system is activated when the child seat 1 for example falls onto the ground.

The connection of the child seat 1 to the vehicle body via ISOfix latching devices 11 in addition has the advantage that a crash pulse of a controller of the vehicle can quickly be transmitted to the control means 18. For this case, it is not required that the control means 18 itself can detect a collision; rather, it is sufficient that it receives and forwards an externally generated signal.

The exemplary embodiment of FIG. 8 corresponds to the exemplary embodiment of FIG. 7 except for the fact that in the exemplary embodiment of FIG. 8 two gas generators 8 are provided, which each are coupled with a valve unit 9 with valves 91. The two gas generators 8 are formed in two cutouts 32, 33 on the back of the backrest 3 of the child seat 1. Each gas generator 8 charges a partial quantity of the inflatable structures formed in the child seat with gas.

The invention is not limited in its design to the exemplary embodiments described above, which should merely be understood by way of example. For example, it can be provided that in addition to inflatable structures arranged on the outside of the child seat, the child seat also includes inflatable structures on the inside of the child seat. Such inflatable structures located on the inside likewise can be filled with gas by a central gas source.

Furthermore, it can be provided for example that the gas source 8 shown in FIGS. 7 and 8 is provided not by a cold gas generator, but by a pyrotechnical gas generator or by a hybrid gas generator. It is also possible that to each inflatable structure a separate gas generator is associated. For this case, gas bag and gas generator form a gas bag module which is arranged at a desired point on the outside of the child seat.

The priority application, German Patent Application Number 10 2011 076 702.9, filed on May 30, 2011 is incorporated by reference herein.

1. A child seat for a motor vehicle. which comprises:
an inside for accommodating a child,
an outside,
at least one inflatable structure which is arranged on the outside of the child seat, and
at least one gas source, wherein in the case of a collision of a motor vehicle in which the child seat is arranged the gas source provides gas for the at least one inflatable structure,
wherein on its outside the child seat comprises at least one first inflatable structure, which during filling with gas is inflated substantially in lateral direction, and on its outside comprises at least one second inflatable structure, which during filling with gas is inflated substantially in a direction towards the front.

2. The child seat according to claim 1, wherein the child seat comprises at least one lateral boundary structure and the first inflatable structure is formed such and arranged on the outside of the lateral boundary structure such that it is inflated substantially in lateral direction away from the lateral boundary structure.

3. The child seat according to claim 1, wherein the child seat comprises at least one lateral boundary structure and the second inflatable structure is formed such and arranged on the outside of the lateral boundary structure such that it is inflated substantially in a direction towards the front away from the lateral boundary structure.

4. The child seat according to claim 3, wherein the inflatable structure is arranged on and/or adjacent to the end face of the lateral boundary structure on the outside thereof.

5. The child seat according to claims 2, wherein the lateral boundary structure is formed by a side bolster of the child seat or by a lateral boundary of a seating region of the child seat.

6. The child seat according to claim 1, wherein in the inflated condition the first inflatable structure, which during filling with gas is inflated substantially in lateral direction, is pressurized with a higher pressure than the second inflatable structure, which during filling with gas is inflated substantially in a direction towards the front.

7. The child seat according to claim 1, wherein to the at least one gas source a valve unit with openable valves is associated, which via at least one gas line is connected with the at least one inflatable structure.

8. The child seat according to claim 7, wherein the gas source is a cold gas generator.

9. The child seat according to claim 1, further comprising a control means, which is provided and formed to control the gas source or a unit connected therewith in the case of a collision of a motor vehicle in which the child seat is arranged, such that gas is provided for inflating the at least one inflatable structure.

10. The child seat according to claim 9, wherein the control means comprises a detection unit which is formed and provided to detect whether the child seat is coupled to an ISOfix latching of a vehicle, wherein the control means triggers a provision of gas only for this case.

11. The child seat according to claim 7, wherein the gas source is a cold gas generator and the control means is provided and formed to open the valves of the valve unit in the case of a collision, so that the at least one inflatable structure is filled with gas of the gas source.

12. The child seat according to claim 1, wherein during filling with gas the inflatable structure is inflated away from the child seat.

13. The child seat according to claim 1, wherein at least one inflatable structure is arranged on the outside of a side bolster of a head region or a seating region of the child seat.

14. The child seat according to claim 1, wherein the at least one inflatable structure comprises at least one folded gas bag.

15. The child seat according to claim 14, wherein on the outside of at least one lateral boundary structure the child seat comprises a plurality of folded gas bags.

16. The child seat according to claim 14, wherein on the outside of at least one lateral boundary structure the child seat comprises at least one folded gas bag, which comprises several chambers or several regions which are deployed in different directions.

17. The child seat according to claim 3, wherein the structure inflatable substantially in a direction towards the front is arranged and formed such that it provides a head protection for a child to be protected, which is sitting in the child seat.
